(19) United States
(12) Patent Application Publication
(10) Pub. No.: US 2005/0066105 A1
(43) Pub. Date: Mar. 24, 2005

(54) Computer system including bios memory storing data for operating a transmission controller

(75) Inventors: Hsien-Yueh Hsu, Taipei City (TW); Te-Chien Lin, Taipei Hsien (TW)

Correspondence Address: BIRCH STEWART KOLASCH & BIRCH, PO BOX 747, FALLS CHURCH, VA, 22040-0747, US

(73) Assignee: ASUSTEK COMPUTER INC., Taipei (TW)

(21) Appl. No.: 10/932,089

(22) Filed: Sep. 2, 2004

(30) Foreign Application Priority Data
Sep. 3, 2003 (TW) 092124369

(51) Int. Cl. G06F 13/00; G06F 13/14

(52) U.S. Cl. 710/305

(57) ABSTRACT

A computer system includes a BIOS memory, an input-and-output chip, and a transmission controller having instructions stored in a portion the BIOS memory. The transmission controller is enabled to read or write the portion of BIOS memory via the input-and-output chip.

### FIELD OF THE INVENTION

The present invention relates to a computer system, specifically to a design for minimizing memory required by a transmission controller of the computer system.

### BACKGROUND OF THE INVENTION

Advance of computer technology has brought a lot of conveniences to our daily life. Therefore, a computer becomes an inevitable part of our daily life, since some of our day-to-day performances, such as searching of reference information or watching news over the network, rely heavily on the computer. The computer generally includes a motherboard and a plurality of IC chips associated with the motherboard. A computer user cares significantly about the quality and stability of the motherboard, since the latter being the most important part of the computer. Computer manufacturers have made a concerted effort to improve the quality and stability of the motherboard.

In addition, the improvement in the semiconductor manufacturing technology further tends to reduce the size of the computer. Variety productions of computer and competitions among the computer manufacturers cause reduction in the cost of a computer so that the computer users are disposed in a state to choose the computer with lower price but with higher quality and better stability.

Referring to FIG. 1, a functional block diagram of a conventional computer is shown to comprise a CPU 10, a north bridge chipset 12, and a south bridge chipset 14. The north bridge chipset 12 is responsible for controlling data transmission among the CPU 10, a RAM 122 and a display unit (not shown). The south bridge chipset 14 is responsible for communicating the CPU 10 with the peripheral devices of the computer. Some of the peripheral devices, such as PCI slot 141, a hard drive (hard disk) 145, a LAN controller 146, USB controller (not shown) and an IEEE1394 controller 148, require relatively high transmission speed. The other peripheral devices, such as a serial port 1421, a parallel port 1422, a floppy 1423, a mouse 1423, and a keyboard 1425, do not require high transmission speed to transmit the data. The data of the aforesaid peripheral devices are executed via a I/O chipset 142, wherein each of the LAN controller 146 and the IEEE1394 controller 148 is individually provided with a distinct ROM 1461 and 1481 (such as EPROM, EEPROM) in order to store the data required by the respective one of the controllers 146,148. The data may be Universal Unique Identifier (UUID) or network address.

In order to reduce the size of a computer and economize the power consumption, the operating components on the motherboard can be designed in such a manner to include lesser components. During planning of a motherboard, in case an operating component on the intended motherboard can be removed without decreasing the proper running of the motherboard, especially for portable computer, the size of the intended motherboard can be reduced while the service life of the battery for running the intended motherboard can be prolonged. In other word, with the same amount of the battery power, the portable computer can work more working hour compared to that of the prior art computer. This distinct feature facilitates the computer user, especially to those who use a portable computer, since the total weight of the computer is greatly reduced.

The present invention provides a design to minimize the memory required by a transmission controller of a computer system so as to cut down the manufacturing cost of a computer, which, in turn, facilitates the computer in such a manner that the LAN controller 146 and the IEEE1394 controller 148 can run in a proper manner without assistance of the ROMs 1461 and 1481.

### SUMMARY OF THE INVENTION

One object of the present invention is to provide a design to reduce the number of components mounted on the motherboard of a computer.

Another object of the present invention is to provide a computer system including a transmission controller having operating instructions stored within a portion of a BIOS memory.

According to a first aspect of the present invention, a computer system is provided to comprise: a basic input-output system (BIOS) memory, an input-and-output chip, and a transmission controller, wherein, the transmission controller reads and writes a portion of the BIOS memory by the use of the input-and-output control chip.

According to a second aspect of the present invention, a computer system is provided to comprise: a CPU having a circuit for processing, controlling and storing data so as to execute and control different fetching and computing functions of the computer system; a north bridge chipset for accessing signals transmission between the CPU, a RAM and a display unit; a south bridge chipset for receiving and transmitting signals from peripheral devices of the computer system and for sending the signals produced from the peripheral devices to the CPU via the north bridge chipset so that the CPU can perform tasks allocation to execute contents of tasks so as to achieve the required functions; a basic input-output system (BIOS) memory for storing programs for setting up and testing different hard drives of the computer system during initialization of the computer in order to ensure normal operation of the computer system; and a transmission controller for receiving and transmitting signals generated by the peripheral devices to the CPU, wherein data required to operate the transmission controller are stored within the basic input-output system (BIOS) memory.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a functional block diagram of a conventional computer system;

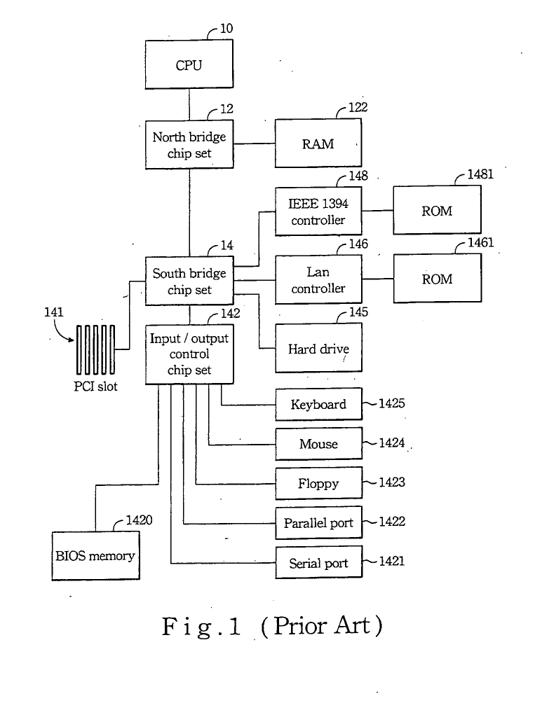

FIG. 2 is a functional block diagram of the preferred embodiment a computer system according to the present invention; and

FIG. 3 is a block diagram illustrating connecting relationship among a transmission controller, a super I/O and a BIOS memory of a computer system according to the present invention.

### DETAILED DESCRIPTION OF THE PREFERRED EMBODIMENTS

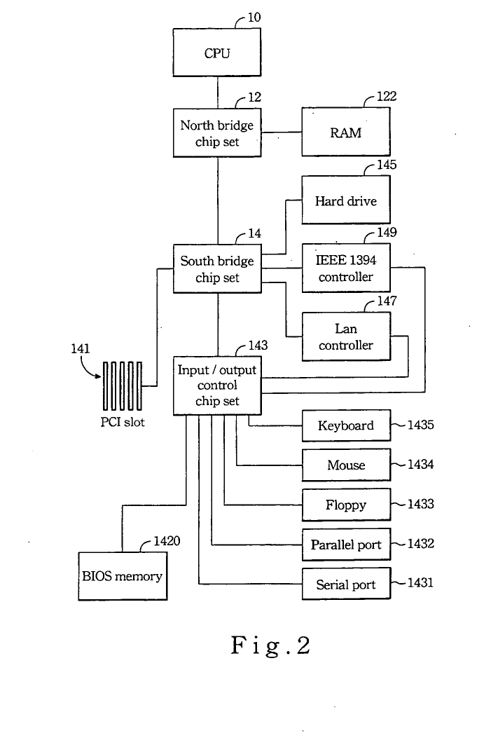

FIG. 2 is a functional block diagram of the preferred embodiment of a computer system according to the present invention. In order to better understanding the present invention, a typical computer available in the market will be used to explain the concept of the present invented. It is known to those skilled in the art, the scope and spirit thereof should not be limited to the preferred embodiment shown in FIG. 2. As illustrated, the motherboard generally comprises a CPU 10, and a chipset, comprising a north bridge chipset 12 and a south bridge chipset 14. The CPU fetches and executes commands of the application program. The north bridge chipset 12 is provided with inner circuits via which instruction produced from the main RAM 122 can be transmitted to the CPU 10 and the display unit (not shown) so that the CPU can execute these instructions, wherein the RAM 122 is capable of storing the data prior to execution and after execution, and the corresponding instruction. The RAM 122 can transmit information via the north bridge chipset 12 to the CPU 10.

The south bridge chipset 14 interconnects electrically the peripheral devices of the computer system and the CPU 10 via a protocol, such as Hub Link defined by Intel, that interconnects the north and south bridge chipsets 12, 14. The south bridge chipset 14 can transmit the signals produced by the peripheral devices to the CPU 10 via the protocol so as to permit the CPU 10 to perform tasks allocation, and to execute contents of the tasks. Some of the peripheral devices, such as a PCI slot 141 (into which PCI/ISA interface cards can be inserted), a hard drive 145, a LAN controller 147, a USB controller (not shown), and an IEEE1394 controller 149 require a relatively high transmission speed to transmit the signals, wherein the USB controller, the LAN controller 147, the IEEE1394 controller 149 are respectively and commonly known as a transmission controller which is adapted to receive and transmit the signals produced by the peripheral devices.

An input-and-output chip 143, such as a I/O controller or a Super I/O, is responsible for receiving and transmitting signals produced by an input-and-out device, is provided with a series of data for reading and writing a BIOS memory 1420, wherein the BIOS memory 1420 is a Flash Rom or an EEPROM, which is provided with a basic computer input-and-output program, a setup program or a pre-loaded computer initiating program, which is responsible for detecting and checking information within the different hard drives of the computer system when the computer is first powered up or reset so as to permit the start up of an operating system, thereby ensuring normal operation of the computer after the start up.

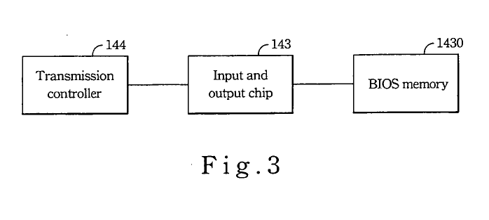

An important aspect to note that, the ROM for the transmission controller comprising the LAN controller 147 and the IEEE1394 controller 149 in the preferred embodiment is not an individual ROM as disclosed in the prior art. Referring to FIG. 3, the transmission controller 144, such as the LAN controller 147 and the IEEE1394 controller 149, has a series of operating instructions or data stored in a portion of the BIOS memory 1430. In other word, a portion of the BIOS memory 1430 is already preserved so as to receive the operating instruction of the transmission controller 144. The operating instructions include data, such as UUID or network address for operating the LAN controller 147 and the IEEE1394 controller 149. Upon receipt of signals from the peripheral electronic devices (such as a network or a digital camera), the transmission controller 144 will transmit the signals to the CPU10 via the south bridge chipset 14 so as to permit the CPU 10 to perform tasks allocation, and to execute contents of the tasks. Meanwhile, the transmission controller 144 can read the corresponding operating instructions stored within the BIOS memory 1430 via the input-and-output chip 143. The aforesaid operating instructions may include data (like Media Access Control, MAC address), which is adapted to recognize the nodes on the network or its product information.

Referring to FIG. 2, in addition the other peripheral devices, like the serial port 1431, the parallel port 1432, the floppy 1433, the mouse 1434, and the keyboard 1435, require low transmission speed and are controlled by the input-and-output chip 143. The signals produced therefrom are transmitted to the CPU 10 via the south bridge chipset 14 so as to permit the CPU to perform the necessary execution of the signals.

The distinguish features provided by the computer system of the present invention are as follows:
(1) By virtue of the design of the present invention, the utility of the memory is reduced, thereby lowering the manufacturing cost of the computer.
(2) Reduction of the components on the motherboard tends to minimize the size of the computer.
(3) Reduction in the components results in lesser usage of the power consumption. For a portable computer, which uses a battery as the power source, the service life to the battery can be prolonged, which in turn, permits the portable computer to run longer working hour compared to the prior art computer. In case, the portable computer is to run under the same amount of working hour as in the past, the battery can be constructed in a more compact size, thereby facilitating the carrying of the portable computer.

An important aspect to note is that the preferred embodiment should not be limited only to the transmission controller (such as LAN controller or IEEE1394 controller). It can be a PLD (programmable logic device), which is adapted to alter the function mode of BIOS memory. In this invention, the PLD may include programs that are stored within the BIOS memory and that are adapted to be readable and written via the input-and-output chip.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A computer system comprising:
a basic input-output system (BIOS) memory;
an input-and-output chip; and
a transmission controller;
wherein, said transmission controller receives a signal from a portion of said BIOS memory via said input-and-output chip.

2. The computer system according to claim 1, wherein said transmission controller is selected from a group consisting of a LAN controller and a IEEE1394 controller.

3. The computer system according to claim 1, wherein said portion of said BIOS memory is used to store data in said transmission controller.

4. The computer system according to claim 1, wherein said input-and-output chip is a super I/O.

5. A computer system comprising:
a CPU having a circuit for processing, controlling and storing data so as to execute and control different fetching and computing functions of the computer system;
a north bridge chipset for accessing signals transmission between said CPU, a RAM and a display unit;
a south bridge chipset for receiving and transmitting signals from peripheral devices of the computer system and for sending said signals produced from said peripheral devices to said CPU via said north bridge chipset so that said CPU can perform tasks allocation to execute contents of said tasks so as to achieve the required functions;
a basic input-output system (BIOS) memory 1420 for storing programs for setting up and testing different hard drives of the computer system during initialization of the computer in order to ensure normal operation of the computer system; and
a transmission controller for receiving and transmitting signals generated by peripheral devices of the computer system to said CPU, wherein data required to operate said transmission controller are stored within said basic input-output system (BIOS) memory.

6. The computer system according to claim 5, further comprising an input-and-output chip (super I/O) for receiving and transmitting signals from an input-and-out device of the computer system, said signals being transmitted to said CPU 10 via said south bridge chipset so that said CPU can perform said tasks allocation to execute contents of said tasks.

7. The computer system according to claim 5, wherein said data stored within said basic input-output system (BIOS) memory are adapted to be read and written via said output-and-input control chip.

8. The computer system according to claim 5, wherein said transmission controller is a LAN controller.

9. The computer system according to claim 5, wherein said transmission controller is an IEEE139 controller.
